(19) United States
(12) Patent Application Publication
(10) Pub. No.: US 2021/0112734 A1
(43) Pub. Date: Apr. 22, 2021

(54) Electric Power Rake For Lawn Care

(71) Applicant: Bluebird Turf Products LLLP, A Delaware Limited Liabiliy Partnership, Auburn Hills, MI (US)

(72) Inventors: Anthony Joseph Carmen, Bloomfield Hills, MI (US); Nicholas Anthony Salvatore, Shelby Township, MI (US)

(21) Appl. No.: 17/073,738

(22) Filed: Oct. 19, 2020

Related U.S. Application Data
(60) Provisional application No. 62/916,653, filed on Oct. 17, 2019.

(51) Int. Cl. A01G 20/43; A01D 89/00; A01D 7/02

(52) U.S. Cl. CPC A01G 20/43; A01D 7/02; A01D 89/005

(57) ABSTRACT

An electric power rake is employed in use to care for lawns. The electric power rake includes a deck housing, multiple wheels, a handle, a battery housing, an electric motor, a pulley assembly, and a working shaft, among other possible components. The battery housing is supported on the deck housing. One or more battery cavities resides in the battery housing. A battery, such as a lithium-ion battery, is received in one of the battery cavities and powers the electric motor. The electric motor has a shaft that drives rotational motion in the pulley assembly. The working shaft is driven to rotate via the pulley assembly and has multiple blades that revolve thereabout when the working shaft rotates.

### CROSS-REFERENCE TO RELATED APPLICATION

This application claims the benefit of U.S. Provisional Patent Application No. 62/916,653, filed Oct. 17, 2019.

### INTRODUCTION

The present disclosure generally relates to lawn care equipment and, more particularly, relates to power rakes used to remove thatch and debris build-up from lawns in yards, gardens, parks, and other areas.

Thatch and debris often build up and layer on a lawn over wintertime, as well as during other seasons. Standard lawn care maintenance and regimes ordinarily call for removal of thatch and debris during the spring season or at other times. Power rakes are equipment used to remove thatch and debris. Power raking typically involves blades that slice thatch and debris. Past power rakes compel movement of their blades by way of gasoline-powered engines.

### SUMMARY

In an embodiment, an electric power rake is employed for use in caring for lawns. The electric power rake may include a deck housing, multiple wheels, a handle, a battery housing, an electric motor, a pulley assembly, and a working shaft. The wheels are situated at the deck housing. The handle extends from the deck housing. The battery housing is supported on the deck housing and has one or more battery cavities for reception of one or more batteries. The electric motor can be powered by the battery(s). The electric motor has a shaft. The pulley assembly includes a first pulley wheel, a second pulley wheel, and a belt. The first pulley wheel is driven to rotate by the electric motor's shaft when the electric motor is activated. The second pulley wheel is driven to rotate by the belt. The belt is carried by the first and second pulley wheels. The working shaft is housed by the deck housing. The working shaft is driven to rotate by the second pulley wheel. The working shaft has multiple blades. The blades revolve about the working shaft when the working shaft is driven to rotate by the second pulley wheel.

In an embodiment, an electric power rake may include a deck housing, multiple wheels, a handle, a bail control bar, a battery housing, a main switch, an electric motor, a pulley assembly, and a working shaft. The wheels are situated at the deck housing. The handle extends from the deck housing. The bail control bar extends from the handle. The battery housing is supported on the deck housing. The main switch is disposed at an exterior of the battery housing. The electric motor is supported on the deck housing and has a shaft. The pulley assembly includes multiple pulley wheels. The pulley assembly is driven to rotate by the electric motor's shaft. The working shaft is housed by the deck housing and is driven to rotate by way of the pulley assembly. The working shaft has multiple blades. In order to activate the electric motor and drive the working shaft to rotate, the main switch is actuated and the bail control bar is brought to a pulled position.

In an embodiment, an electric power rake may include a deck housing, multiple wheels, a handle, a bail control bar, a battery housing, a main switch, an electric motor, an electronic control unit, a pulley assembly, and a working shaft. The wheels are situated at the deck housing. The handle extends from the deck housing. The bail control bar extends from the handle. A bail cable spans from the bail control bar. The battery housing is supported on the deck housing. One or more batteries are received in the battery housing. The main switch is disposed at an exterior of the battery housing. The electric motor is supported on the deck housing and has a shaft. The electronic control unit is in electrical communication with the main switch, and is in electrical communication with the electric motor. The pulley assembly includes a first pulley wheel, a second pulley wheel, an idler pulley wheel, and a belt. The first pulley wheel is driven to rotate by the electric motor's shaft. The belt is looped around the first pulley wheel, the second pulley wheel, and the idler pulley wheel. The working shaft is housed by the deck housing and is driven to rotate by way of the pulley assembly. The working shaft has multiple blades. In order to activate the electric motor and drive the working shaft to rotate, the main switch is actuated and the bail control bar is brought to a pulled position. Bringing the bail control bar to the pulled position prompts movement of the idler pulley wheel via the bail cable. The belt is thereby drawn taut.

### BRIEF DESCRIPTION OF THE DRAWINGS

One or more aspects of the disclosure will hereinafter be described in conjunction with the appended drawings, wherein like designations denote like elements, and wherein:

FIG. 1 is a perspective view of an embodiment of an electric power rake;

FIG. 2 is a rightside view of the electric power rake;

FIG. 3 is bottom view of the electric power rake;

FIG. 4 is a leftside view of the electric power rake;

FIG. 5 is a sectional view of the electric power rake taken at arrowed lines 5-5 in FIG. 4; and

FIG. 6 is a front view of another embodiment of the electric power rake.

### DETAILED DESCRIPTION

Referring to the drawings, embodiments of an electric power rake 10 are presented in the figures and detailed in this description. The electric power rake 10 is of the walk-behind type and is employed in use to sever and remove thatch and debris build-up in grass lawns for yards, gardens, parks, and other areas including private and public areas, as well as residential and commercial areas. Compared to past gasoline-powered power rakes with gasoline engines, the electric power rake 10 is battery-powered and has a significant reduction in noise, vibration, and harshness (NVH). Diminished vibration at the electric power rake's handle means that an operator can physically operate the electric power rake 10 for a longer period of time. And diminished noise emitted by the electric power rake 10 means that it can be operated at times that would otherwise be prohibitive by local ordinances or off-limits in other respects such as during early morning hours. Since it is battery-powered, the electric power rake 10 is cordless. The electric power rake 10 is also lighter in weight and better for the environment than the gasoline-powered power rakes of the past.

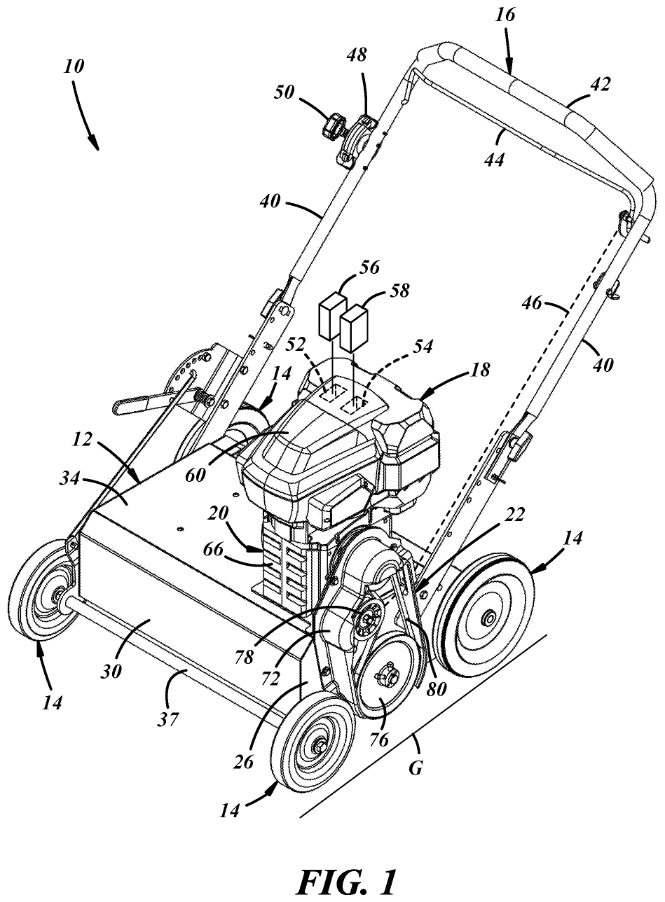

The electric power rake 10 can have various designs, constructions, and components in different embodiments depending upon—among other possible factors—the type of power rake (e.g., walk-behind, towable) and its size. In an embodiment of FIGS. 1-5, for example, the electric power rake 10 has, as some of its primary components, a deck housing 12, wheels 14, a handle 16, a battery housing 18, an electric motor 20, a pulley assembly 22, and a working shaft 24; still, the electric power rake could have more, less, and/or different components in other embodiments. The deck housing 12 houses certain components of the electric power rake 10 and supports others, and serves as a main body of the electric power rake 10. At an underside the deck housing 12 houses the working shaft 24, and at an exterior the deck housing 12 supports the wheels 14, the handle 16, the electric motor 20, and the pulley assembly 22. The battery housing 18 is indirectly supported by the deck housing 12 by way of the electric motor 20 in this embodiment. The deck housing 12 here is an assemblage of metal walls: a first sidewall 26, a second sidewall 28, a front wall 30, a rear wall 32, and a top wall 34. The walls of the deck housing 12 establish an interior 36 with an open bottom. The wheels 14, four in total, are situated at the deck housing 12 and provide rolling traversal of the electric power rake 10 over an underlying ground surface G (FIG. 1). A front wheel axle 37 holds a front pair of the wheels 14, and likewise a rear wheel axle 38 holds a rear pair of the wheels 14. The front and rear wheel axles 37, 38 are mounted to the deck housing 12 and particularly to the first and second sidewalls 26, 28.

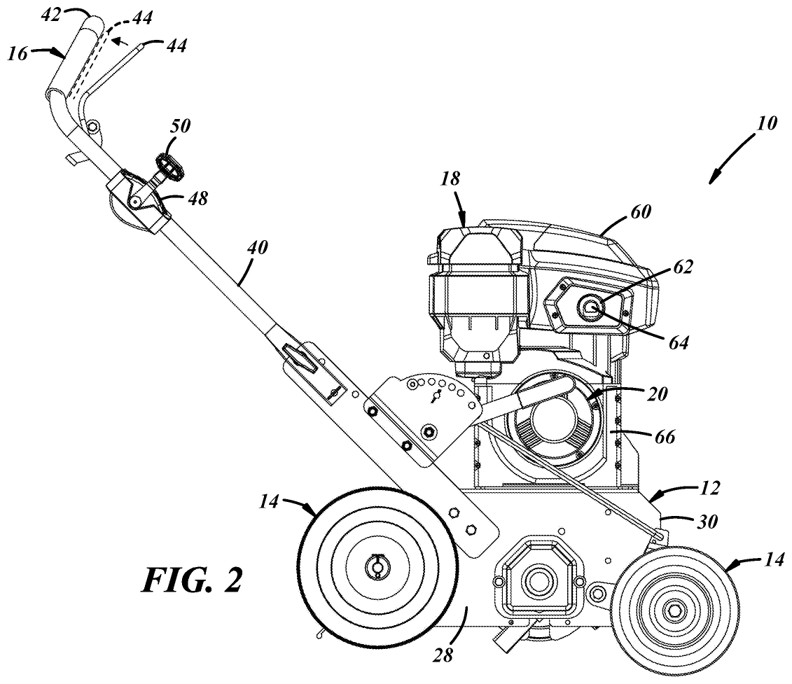

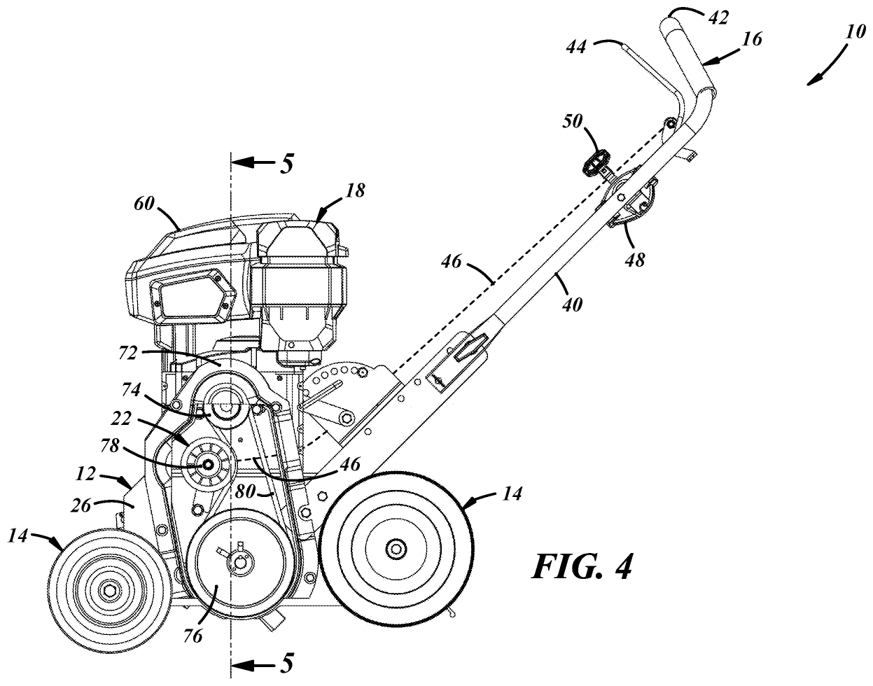

The handle 16 extends from the deck housing 12 and can be grasped by the operator amid use of the electric power rake 10. The handle 16 has a pair of side arms 40 mounted at their proximal ends to the deck housing 12 and mounted particularly to the first and second sidewalls 26, 28. A handlebar 42 extends between the side arms 40. To prompt rotation of the working shaft 24, a bail control bar 44 and a bail cable 46 are provided at the handle 16. The bail control bar 44 is pivotably connected to the side arms 40 and can be moved by the operator from a released position, as presented in FIG. 1, to a pulled position as represented in FIG. 2 by the broken-line depiction of the bail control bar 44. The bail control bar 44 is spring-biased to the released position. The bail cable 46 is represented in FIGS. 1 and 4 by a broken-line depiction. The bail cable 46 spans between the bail control bar 44 and an idler pulley wheel (described below) of the pulley assembly 22. The bail cable 46 is connected at one end to the bail control bar 44, and is connected at its other, opposite end to the idler pulley wheel. Pulling the bail control bar 44 to its pulled position concurrently pulls the bail cable 46 and hence the idler pulley wheel. Furthermore, a speed controller 48 is situated at the handle 16, and is particularly connected to one of the side arms 40. The speed controller 48 is manipulated by the operator to manage the speed of the spinning rotation of the electric motor 20, and can have distinct speed settings. The speed controller 48 can electrically communicate with an electronic control unit (described below) of the electric power rake 10 via wiring and circuitry. A shifter 50 can be used to set the speed controller 48 in its different speed settings.

The battery housing 18 serves as a battery holder for the electric power rake 10. The battery housing 18 can be composed of a plastic material. In this embodiment, the battery housing 18 is situated directly on top of the electric motor 20, constituting a vertically-stacked configuration of the battery housing 18 and electric motor 20. The vertically-stacked configuration has been found to facilitate packaging among the components of the battery housing 18 and electric motor 20, and facilitates the establishment of electrical communication thereamong. Together, the vertically-stacked battery housing 18 and electric motor 20 constitute a powerhead of the electric power rake 10. As depicted in FIG. 1, a first battery cavity 52 and a second battery cavity 54 reside within the battery housing 18; still, in other embodiments a single battery cavity could be provided. The first and second battery cavities 52, 54 receive respective insertion of a first and second battery 56, 58; in an embodiment with a single battery cavity, a single battery could be provided. The first and second battery cavities 52, 54 are wholly enclosed by the battery housing 18 and reside at the battery housing's interior. A top cover 60 can be hinged on a larger body and can be opened for access to the first and second cavities 52, 54 and for inserting and removing the first and second batteries 56, 58. Once closed, as depicted in FIG. 1, the first and second battery cavities 52, 54 and first and second batteries 56, 58 are protected against the external environment. The first and second battery cavities 52, 54 have battery receptors to suitably accept power discharge from the first and second batteries 56, 58. Electrical communication can be provided between the first and second battery cavities 52, 54 and batteries 56, 58 and the electric motor 20.

The first and second batteries 56, 58 provide power to the electric motor 20, and can be of various types and can have various specifications in different embodiments. In an example, the first and second batteries 56, 58 are lithium-ion batteries. Here, specifications for a battery pack can include: a rated voltage of 125V d.c., a rated capacity of 2500 mAh, a maximum discharge current of 20 A, and a charging voltage/current of 126V d.c./4 A. Still, other specifications for the battery pack may be suitable. In this example, specifications for a battery cell can include: a rated capacity of 2500 mAh, a charging voltage of up to 4.2V d.c., and a discharging voltage of up to 2.7V d.c. Still, other specifications for the battery cell may be suitable.

With reference now to FIG. 2, a main switch 62 is disposed at an exterior of the battery housing 18 and, in particular, is located on a side of the battery housing 18 for ready access by the operator; other locations at the exterior of the battery housing 18 are contemplated in other embodiments. The main switch 62 serves as an ON/OFF switch for the electric power rake 10. The operator actuates and de-actuates the main switch 62 by physically pressing it. When actuated, the electric motor 20 is ON and activated; and when de-actuated, the electric motor 20 is OFF and deactivated. To protect the main switch 62 and its wiring and circuitry against external liquid and moisture like water, a cover 64 is provided over the main switch 62. The cover 64 fully seals the main switch 62 at all sites of potential exposure. The cover 64 can be flexible and can be composed of a silicone material. In one example the cover 64 achieves a waterproof protection rating of IP65, meaning that water projected by a nozzle against it from any direction has no harmful effects. The location of the main switch 62 at the exterior of the battery housing 18 has been found to facilitate its electrical communication with the electronic control unit of the electric power rake 10, and has been found to facilitate its sealing and waterproof protection compared to locations elsewhere on the electric power rake 10.

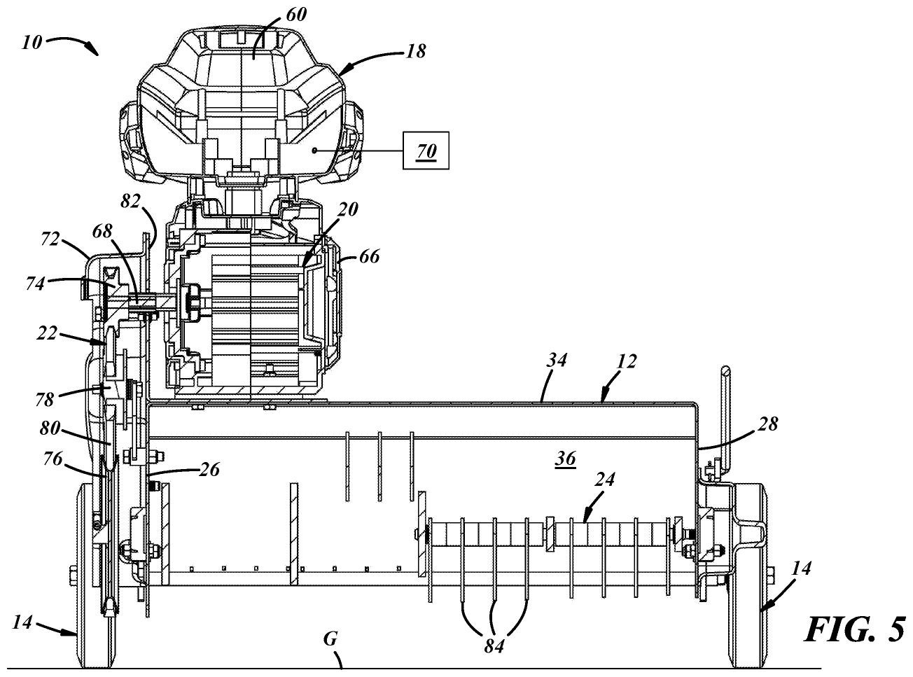

The electric motor 20 incites rotational drive and movement of the working shaft 24 amid use of the electric power rake 10. Output torque is transferred from the electric motor 20 and to the working shaft 24 via the pulley assembly 22. The electric motor 20 is powered by the first and second batteries 56, 58. In this embodiment, the electric motor 20 is situated on the deck housing 12 and seated on the top wall 34. An electric motor housing 66 houses components of the electric motor 20 including its rotor, stator, windings, and commutator, among other components. The electric motor housing 66 can be composed of a plastic material. The electric motor housing 66 can be a separate and distinct structure from the battery housing 18, or can be a unitary and monolithic structure of the battery housing 18. With particular reference to FIG. 5, a shaft 68 of the electric motor 20 extends from the electric motor housing 66 for connection with a first pulley wheel (described below) of the pulley assembly 22. The shaft 68 spins and rotates when the electric motor 20 is activated and outputs rotational drive to the first pulley wheel. Due to the arrangement of the electric motor 20 on the deck housing 12, the shaft 68 exhibits a horizontal arrangement in assembly with respect to the underlying ground surface G. In an example, specifications of the electric motor 20 can include: a voltage of 125V DC, a rated output of 2150 W, a rated speed of 2900 RPM, a rated current of 20 A, and a rated torque of 7.0 N.M. Still, other specifications for the electric motor 20 may be suitable.

An electronic control unit 70 is programmed to manage operation of the electric power rake 10, including activation and deactivation of the electric motor 20 and speed control of the electric motor 20, among other possible operational functionalities. The electronic control unit 70 is depicted in FIG. 5. In this embodiment, the electronic control unit 70 is housed in the battery housing 18, but could be located elsewhere such as at the electric motor housing 66 in other embodiments. The electronic control unit 70 can have electrical communication via wiring and circuitry with the electric motor 20, with the speed controller 48, with the first and second battery cavities 52, 54, and with the main switch 62. By way of the electrical communications, the electrical control unit 70 receives operational commands and instructions from the speed controller 48 and from the main switch 62, and in turn sends operational commands and instructions to the electric motor 20.

The pulley assembly 22 transfers rotational drive output and torque output from the electric motor 20 and to the working shaft 24 amid use of the electric power rake 10. The pulley assembly 22 receives rotational drive and torque output from the shaft 68, and imparts rotational drive and torque input to the working shaft 24. A torque increase is effected by the pulley assembly 22 from the electric motor 20 and to the working shaft 24. In this embodiment, and with reference to FIGS. 1 and 4, the pulley assembly 22 is generally arranged vertically and spans between the electric motor 20 and the working shaft 24. The pulley assembly 22 here includes a pulley cover 72, a first pulley wheel 74, a second pulley wheel 76, an idler pulley wheel 78, and a belt 80. The pulley cover 72 is mounted over the other components of the pulley assembly 22 and encloses them. The pulley cover 70 is attached to the first sidewall 26 and attached to a plate 82 (FIG. 5) extending from the top wall 34. The pulley wheels 74, 76, 78 are grooved at their outside circumferences for seating of the belt 80. The first pulley wheel 74 is mounted on the shaft 68 of the electric motor 20 and is driven to rotate by the shaft 68. The second pulley wheel 76 has a larger diameter and circumference than the first pulley wheel 74. The second pulley wheel 76 is mounted on an end portion of the working shaft 24 and imparts rotational drive and torque input to the working shaft 24. The second pulley wheel 76 is driven to rotate by the first pulley wheel 74 via the belt 80.

The idler pulley wheel 78 engages the belt 80 to draw the belt taut and tight, hence enabling the transfer of rotational drive from the first pulley wheel 74 and to the second pulley wheel 76. The idler pulley wheel 78 has a connection to the bail cable 46 and can be mounted to the first sidewall 26 or to the plate 82. The idler pulley wheel 78 is movable between two positions. In a first position, the idler pulley wheel 78 is set back from the belt 80 and lacks engagement with the belt 80 or only slightly engages the belt 80. Here, the belt 80 is drawn somewhat loosely around the first and second pulley wheels 74, 76 and is able to slip, and therefore does not transfer rotational drive from the first pulley wheel 74 to the second pulley wheel 76. The idler pulley wheel 78 is spring-biased to the first position and, absent pulling by the bail cable 46, is normally set in the first position. In a second position, the idler pulley wheel 78 is displaced forward toward the belt 80 and tightly engages the belt 80. Here, any previous looseness or slack is removed from the belt 80, and the belt 80 is tightly drawn around the first and second pulley wheels 74, 76. Rotational drive is transferred via the belt 80 from the first pulley wheel 74 to the second pulley wheel 76 when the idler pulley wheel 78 is in the second position. Movement of the idler pulley wheel 78 to the second position is caused by being pulled by the bail cable 46 when the bail control bar 44 is brought to its pulled position. The belt 80 is endless, can be composed of a rubber material, and is looped around the first and second pulley wheels 74, 76.

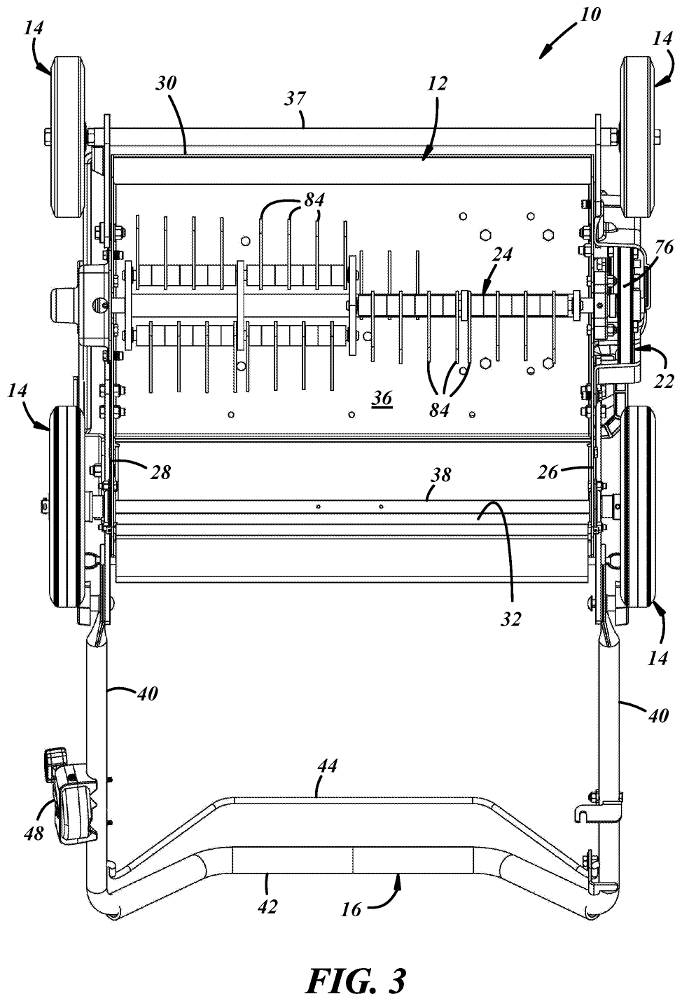

The working shaft 24 effects severing and removal of thatch and debris build-up amid use of the electric power rake 10. With reference to FIGS. 3 and 5, the working shaft 24 is housed by the deck housing 12 and is located at the interior 36. The working shaft 24 spans across the open bottom of the interior 36 and is mounted to the first sidewall 26 at one of its ends, and is mounted to the second sidewall 28 at its other end. At its end adjacent the first sidewall 26, the working shaft 24 is mounted with the second pulley wheel 76 whereby rotation of the second pulley wheel 76 causes concurrent rotation of the working shaft 24. Multiple blades 84 are carried by the working shaft 24 and are arranged across the longitudinal extent of the working shaft 24. The blades 84 are suspended from the working shaft 24 within the interior 36 and rapidly revolve about the working shaft 24 when the working shaft 24 rotates. The blades 84 sever underlying thatch and debris build-up.

In operation, the electric power rake 10 has a two-step safety starting procedure. First, the operator actuates the main switch 62 by pressing it. The electric motor 20 is thus activated. When activated, the shaft 68 of the electric motor 20 spins. Because the idler pulley wheel 78 is normally set in its first position, rotational drive is not transferred to the second pulley wheel 76. Consequently, the working shaft 24 and blades 84 remain static and lack rotation and revolving in this instance. Second, in order to cause rotation of the working shaft 24 and revolving of the blades 84, the operator pulls the bail control bar 44 to its pulled position. The bail cable 46 in turn pulls the idler pulley wheel 78 to the second position. Slack in the belt 80 is taken up by the idler pulley wheel 78, and rotational drive is transferred to the second pulley wheel 76. The working shaft 24 now rotates and the blades 84 revolve. These steps, first and second, when performed in succession serve to initiate rotation of the working shaft 24.

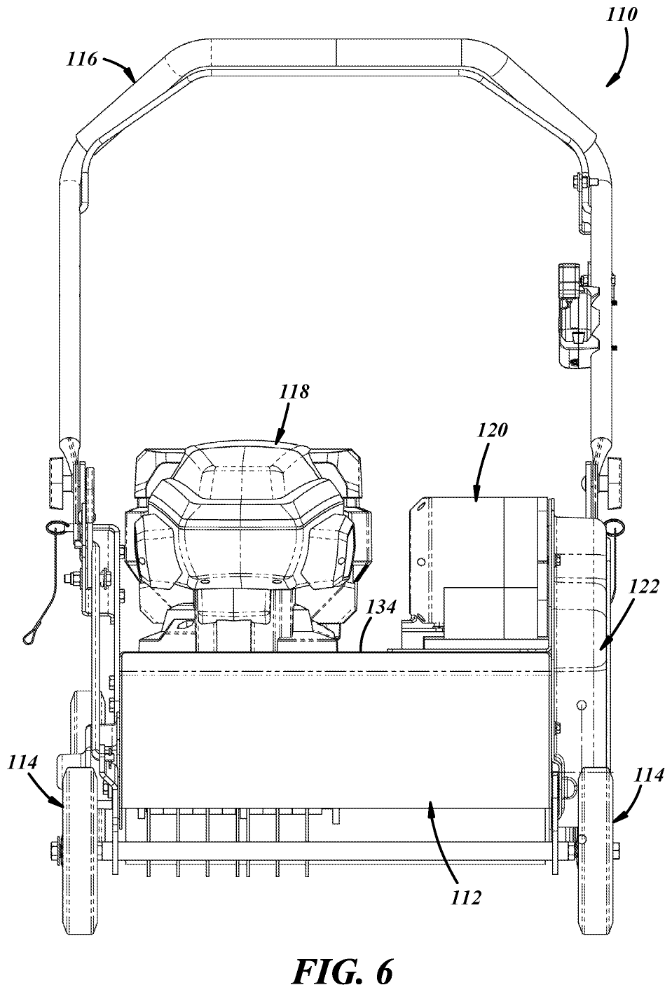

Another embodiment of an electric power rake 110 is presented in FIG. 6. The electric power rake 110 of FIG. 6 is similar to the electric power rake 10 described with reference to FIGS. 1-5, and many of the similarities will not be repeated here. As before, the electric power rake 110 has a deck housing 112, wheels 114, a handle 116, a battery housing 118, an electric motor 120, a pulley assembly 122, and a working shaft (not shown in FIG. 6). One primary difference in this embodiment is the location and arrangement of the battery housing 118 relative to the electric motor 120. The electric motor 120 is situated on the deck housing 112 and seated on a top wall 134, as before. Unlike the previous embodiment, the battery housing 118 in this embodiment is itself situated on the deck housing 112 and seated on the top wall 134. The battery housing 118 and electric motor 120 hence exhibit a side-by-side configuration.

It is to be understood that the foregoing is a description of one or more aspects of the disclosure. The disclosure is not limited to the particular embodiment(s) disclosed herein, but rather is defined solely by the claims below. Furthermore, the statements contained in the foregoing description relate to particular embodiments and are not to be construed as limitations on the scope of the disclosure or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. An electric power rake for lawn care, comprising:
a deck housing;
a plurality of wheels situated at said deck housing;
a handle extending from said deck housing;
a battery housing supported on said deck housing and having at least one battery cavity for reception of at least one battery;
an electric motor powerable via the at least one battery, said electric motor having a shaft;
a pulley assembly including a first pulley wheel, a second pulley wheel, and a belt carried by said first and second pulley wheels, said first pulley wheel driven to rotate by said shaft of said electric motor upon activation of said electric motor, said second pulley wheel driven to rotate by said belt; and
a working shaft housed by said deck housing and driven to rotate by said second pulley wheel, said working shaft having a plurality of blades, said plurality of blades revolving about said working shaft when said working shaft is driven to rotate by said second pulley wheel.

2. The electric power rake as set forth in claim 1, further comprising a bail control bar and a bail cable, said bail control bar situated at said handle;
wherein said pulley assembly includes an idler pulley wheel, said bail cable spanning from said bail control bar to said idler pulley wheel;
wherein, amid use of the electric power rake, when said bail control bar is brought to a pulled position, said idler pulley wheel engages said belt and draws said belt taut and rotational drive is transferred from said first pulley wheel to said second pulley wheel.

3. The electric power rake as set forth in claim 1, further comprising a main switch that activates said electric motor upon actuation and that deactivates said electric motor upon de-actuation, said main switch disposed on said battery housing.

4. The electric power rake as set forth in claim 3, wherein said main switch is disposed at an exterior of said battery housing and is accessible by a user at the exterior of said battery housing, said main switch having a cover that seals said main switch against external liquid.

5. The electric power rake as set forth in claim 4, wherein said main switch electrically communicates with an electronic control unit of the electric power rake, the electronic control unit being in electrical communication with said electric motor.

6. The electric power rake as set forth in claim 1, further comprising an electronic control unit in electrical communication with the at least one battery and in electrical communication with said electric motor.

7. The electric power rake as set forth in claim 6, further comprising a speed controller situated at said handle and being in electrical communication with said electronic control unit, said speed controller managing speed of said shaft of said electric motor.

8. The electric power rake as set forth in claim 1, further comprising at least one battery received in said at least one battery cavity, said at least one battery providing power to said electric motor upon activation of said electric motor.

9. The electric power rake as set forth in claim 1, wherein said at least one battery cavity is a first battery cavity and a second battery cavity, and further comprising a first battery received in said first battery cavity and a second battery received in said second battery cavity.

10. The electric power rake as set forth in claim 1, wherein said battery housing and said electric motor exhibit a vertically-stacked configuration relative to each other and are supported on said deck housing.

11. The electric power rake as set forth in claim 1, wherein said shaft of said electric motor is arranged horizontally.

12. The electric power rake as set forth in claim 1, further comprising a main switch and a bail control bar, wherein, in order to activate said electric motor and drive said working shaft to rotate and revolve said plurality of blades about said working shaft, said main switch is actuated and said bail control bar is pulled in succession.

13. An electric power rake for lawn care, comprising:
a deck housing;
a plurality of wheels situated at said deck housing;
a handle extending from said deck housing;
a bail control bar extending from said handle;
a battery housing supported on said deck housing;
a main switch disposed at an exterior of said battery housing;
an electric motor supported on said deck housing, said electric motor having a shaft;
a pulley assembly including a plurality of pulley wheels, said pulley assembly driven to rotate by said shaft of said electric motor; and
a working shaft housed by said deck housing and driven to rotate via said pulley assembly, said working shaft having a plurality of blades;
wherein, in order to activate said electric motor and drive said working shaft to rotate, said main switch is actuated and said bail control bar is brought to a pulled position.

14. The electric power rake as set forth in claim 13, further comprising a bail cable spanning from said bail control bar to said pulley assembly, said bail cable prompting movement of one of said plurality of pulley wheels when said bail control bar is brought to the pulled position.

15. The electric power rake as set forth in claim 13, further comprising an electronic control unit in electrical communication with said main switch and in electrical communication with said electric motor.

16. The electric power rake as set forth in claim 13, further comprising at least one battery received in said battery housing.

17. An electric power rake for lawn care, comprising:
a deck housing;
a plurality of wheels situated at said deck housing;
a handle extending from said deck housing;
a bail control bar extending from said handle, a bail cable spanning from said bail control bar;
a battery housing supported on said deck housing, at least one battery received in said battery housing;
a main switch disposed at an exterior of said battery housing;
an electric motor supported on said deck housing, said electric motor having a shaft;
an electronic control unit in electrical communication with said main switch and in electrical communication with said electric motor;
a pulley assembly including a first pulley wheel, a second pulley wheel, an idler pulley wheel, and a belt looped around said first and second and idler pulley wheels, said first pulley wheel driven to rotate by said shaft of said electric motor; and
a working shaft housed by said deck housing and driven to rotate via said pulley assembly, said working shaft having a plurality of blades;
wherein, in order to activate said electric motor and drive said working shaft to rotate, said main switch is actuated and said bail control bar is brought to a pulled position, bringing said bail control bar to the pulled position prompts movement of said idler pulley wheel via said bail cable and said belt is drawn taut.
